(19) United States
(12) Patent Application Publication
(10) Pub. No.: US 2007/0272608 A1
(43) Pub. Date: Nov. 29, 2007

(54) COLLOIDAL POLYSULFONE FIBERS

(76) Inventor: Mark M. Clark, Urbana, IL (US)

Correspondence Address: EVAN LAW GROUP LLC, 600 WEST JACKSON BLVD., SUITE 625, CHICAGO, IL, 60661, US

(21) Appl. No.: 11/420,100

(22) Filed: May 24, 2006

(51) Int. Cl. B01D 39/16

(52) U.S. Cl. 210/500.41

(57) ABSTRACT

Colloidal fibers and devices including colloidal fibers for the purification of water are provided. The fibers include colloidal particles having average diameters from 10 to 1000 nm that include a sulfone polymer. The length of the fibers is at least three times their average cross-sectional width of 35 to 400 μm. The fibers may be made from a solution including the sulfone polymer and a solvent that is mixed with water. The fibers may remove organic matter from water and be regenerated with an alkali solution.

### BACKGROUND

Dissolved organic matter contaminants typically found in water supplies include man-made compounds and the natural products of plant decay, including humic acid, which can give undesirable color, taste, and odor to water. Dissolved organics also interfere with water purification processes by clogging filters and fouling resin beds. Furthermore, during treatment of the water supply at drinking water treatment facilities, natural organic matter can react with chemical disinfectants, such as chlorine, to produce chlorinated-organic compounds, many of which are carcinogenic.

Activated carbon conventionally has been used to adsorb organic matter contaminants from water supplies. Typically, carbon filters are used prior to other purification processes to partially purify the water and prevent fouling of ion-exchange beds or membranes. Presently, activated carbon pre-filters are used before high performance water purification membranes, such as reverse osmosis membranes. Without a pre-filter, such membranes would rapidly clog with organic matter contaminants. However, activated carbons have the disadvantage of requiring disposal or regeneration after their adsorption capacity is exhausted. Many activated carbons, including those in powdered form, are never regenerated and remain in the residuals or sludges generated from water treatment. These residuals or sludges must then be disposed of as solid waste, usually in a landfill, which poses a secondary pollution problem.

In addition to adsorbents, such as activated carbon, various types of filter membranes have been used to remove microorganisms and other insoluble contaminants from water. Unlike adsorbents having a chemical affinity for the contaminants, filters work by physically excluding the contaminants from the water. Thus, the contaminants remain on one side of the filter while the purified water passes through. For example, in U.S. Pat. App. Pub. No. 2003/0052055, liquids are forced under pressure through porous, hollow fiber membranes formed from one type of polysulfone polymer. While retaining the contaminants within the interior of the fiber, the pores allow the purified liquid to pass through to the exterior of the fiber. Similarly, in U.S. Pat. No. 4,874,522, hollow fiber membranes having multiple porosities were used to exclude the passage of albumin and insulin at a higher rate than water. Because filters work through size exclusion, they lack the ability of adsorbents to adhere the contaminants.

### SUMMARY

Colloidal fibers are provided including colloidal particles having average diameters from 10 to 1000 nm that include a sulfone polymer. The length of the fibers is at least three times their average cross-sectional width of 35 to 400 μm. The fibers may be made from a solution including the sulfone polymer and a solvent. The fibers may remove organic matter from water and be regenerated with an alkali solution.

In another aspect, a device is provided that includes colloidal fibers including colloidal particles having average diameters from 10 to 1000 nm that include a sulfone polymer. The length of the fibers is at least three times their average cross-sectional width of 35 to 400 μm.

The following definitions are included to provide a clear and consistent understanding of the specification and claims.

The terms “soluble” or “solubilized” mean a solid solvated in a liquid to provide a solution, where a solution, unlike a dispersion, suspension, or mixture, lacks an identifiable interface between the solubilized solid and the solvent. Thus, in solutions, the solubilized solid is in direct contact with the solvent, while in colloidal suspensions only the surface of the colloidal particles are in direct contact with the liquid.

The term “adsorption” means a type of adhesion taking place at a surface in contact with molecules resulting in the accumulation of the molecules at the surface.

The term “colloidal particle” means a colloid suspended in a liquid having an average diameter of 10 to 1000, 20 to 500, 30 to 80, or 35 to 65 nanometers (nm).

The term “aggregate” means a collection of colloidal particles having a generally spherical, but irregular shape.

The term “fiber” means a collection of colloidal particles having an average length at least three times its average cross-sectional width.

### BRIEF DESCRIPTION OF THE DRAWINGS

The invention can be better understood with reference to the following figures and description. The components in the figures are not necessarily to scale, emphasis instead being placed upon illustrating the principles of the invention.

FIG. 1A represents an example of water purification device including the colloidal fibers of the present invention.

FIG. 1B represents a laboratory scale synthesis apparatus for forming colloidal fibers.

FIG. 2A is a SEM image of colloidal fibers at low resolution (˜200 μm).

FIG. 2B is a SEM image of the surface of a colloidal fiber at high resolution (˜500 nm).

FIG. 3A plots the nitrogen desorption data for the prior colloidal aggregates.

FIG. 3B plots the nitrogen desorption data for the colloidal fibers of the present invention.

FIG. 4 compares flux decline for raw lake water and lake water passed over colloidal fibers of the present invention.

FIGS. 5A-5D are SEM images of polysulfone fibers made with 3%, 4%, 6%, and 8% polysulfone to NMP (w/w), respectively.

### DETAILED DESCRIPTION

The colloidal fibers of the present invention may replace powdered activated carbon in water purification systems. Presently, activated carbon is used during the purification of drinking water for taste and odor control and for the adsorption of natural and synthetic organic pollutants. Rather than being discarded in the water treatment sludge, as conventionally done with activated carbon, the fibers may be regenerated and reused. Additionally, the fibers may be used in place of an activated carbon pre-filter. When the fibers are made from the same or similar polymer as the purification membrane, superior pre-filtration is possible.

In U.S. Pat. No. 6,669,851 sulfone polymer colloids were disclosed that purified water. When these colloidal aggregates were added to water containing organic matter contaminants, the contaminants were adsorbed onto the colloids. Removal of the colloids from the water resulted in the removal of the organic matter, purifying the water. The colloids could be regenerated, or cleaned of the adsorbed organic matter, by exposing them to base. The regenerated colloids could then be reused.

The colloidal fibers of the present invention similarly may be used for the purification of water. The colloidal fibers include sulfone polymer colloidal particles having a colloidal exterior. The colloidal particles forming the fibers impart the contaminant adsorptive properties of the prior aggregates to fibers.

In one aspect, about 20% of the total surface area of the prior colloidal aggregates was lost when colloidal fibers were formed. In another aspect, colloidal fibers have total surface areas of 20 to 100 m²/g. In another aspect, colloidal fibers have total surface areas of 60 to 90 m²/g or 75 to 85 m²/g. These total surface areas are significantly higher than those of non-colloidal polysulfone fibers generally used in size exclusion-type water purification systems.

Hollow polysulfone fibers conventionally have been used for size-exclusion water purification by passing contaminated water through pores in the outer surface of the tubular fibers. If contaminated water is passed through the interior of these hollow fibers under pressure, purified water is provided on the exterior of the fiber. Conversely, when contaminated water is drawn into the tubular fiber from the exterior by vacuum, purified water is provided within the fiber.

Unlike conventional tubular fibers, the colloidal fibers of the present invention include colloidal particles, similar to the colloidal particles described in U.S. Pat. No. 6,669,851. Thus, colloidal fibers purify water in a fundamentally different way than conventional size exclusion fibers. When contaminated water flows over the exterior of the fibers of the present invention, the contaminants are adsorbed by the colloidal particles. While not wishing to be bound by any particular theory, it is presently believed that organic matter diffuses into the interior of the fibers and is adsorbed by the nanometer-sized colloids. The average interstitial distance between the colloidal particles of the present fibers range from 10 to 20 nm. These small features provide a large total surface area, as is desirable when adsorption, as opposed to mechanical exclusion, is performed by the fibers.

While the microstructure of the present fibers is different than that of the prior aggregates described in U.S. Pat. No. 6,669,851 (fibers versus aggregates), the colloidal particles that form the fibers are similar to those that previously formed the aggregates. In this way, the colloidal fibers of the present invention retain the beneficial adsorptive properties of the colloidal aggregates, while allowing the benefits of a larger, elongated microstructure. Furthermore, the colloidal fibers of the present invention may be similarly regenerated as the prior colloidal aggregates.

Compared to the prior aggregates, the present colloidal fibers are larger, having average cross-sectional widths of 35 to 400, 40 to 250, or 50 to 150 μm. Due to the irregular surfaces, average cross-sectional widths for the fibers, determined by analysis of SEM images, were used. The colloidal fibers also have a defined shape in relation to the prior aggregates, having average lengths at least three times, preferably at least 5, 10, 50, or 100 times, their average cross-sectional width.

By selecting the mass of the polysulfone polymer in relation to the mass of the solvent, colloidal fibers of varying lengths may be formed. Unless stated otherwise, all percents are on a weight/weight (w/w) basis. While larger amounts of the polysulfone polymer in relation to the amount of the solvent provides fibers having increased lengths and average cross-sectional widths, the surface area of the fibers, and their corresponding ability to adsorb organic matter, decreases. Thus, depending on the application, the length and average cross-sectional width of the fibers may be tuned in relation to the desired adsorption. In Table I below, the correlation between percent polymer, surface area, and the average interstitial distance between the particles may be seen.

TABLE I

| | | Average Interstitial |
|---|---|---|
| Percent Polysulfone | | Distance Between |
| Polymer (w/w) | BET surface area (m²/g) | Particles (nm) |
| 3% | 70.1 | 10.6 |
| 4% | 61.8 | 7.7 |
| 5% | 48.5 | 18.1 |
| 6% | 15.3 | 21.2 |

Unlike the prior aggregates that moved relatively freely in liquids, thus being potentially difficult to recover from the water after purification, the present fibers may be packed into columns, formed into woven or unwoven substrates, or otherwise fixed in relation to flowing water. In one aspect, the present fibers may be mixed with or formed in the presence of other fibers, such as non-adsorption fibers, to further increase mechanical strength. Thus, the contaminated water may flow over the colloidal fibers while the fibers are held in a column or in the form of a substrate. By mechanically isolating the adsorptive colloidal particles from the water as fibers, the ease of removing and regenerating the particles in relation to those of the prior “free” aggregates may be substantially increased. Furthermore, because fibers may be packed into columns or formed into substrates, they may mechanically trap larger species, thus functioning as a filter in addition to an adsorbent.

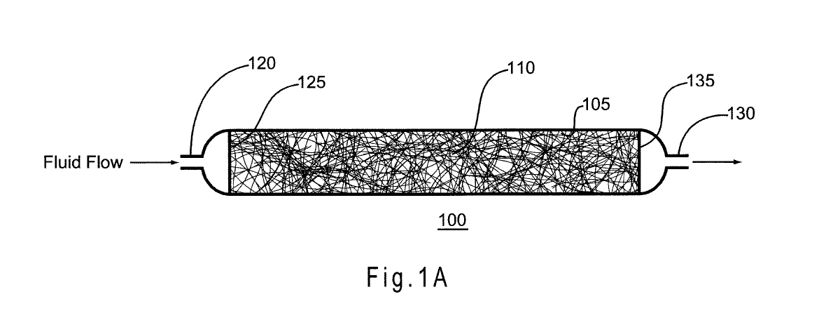

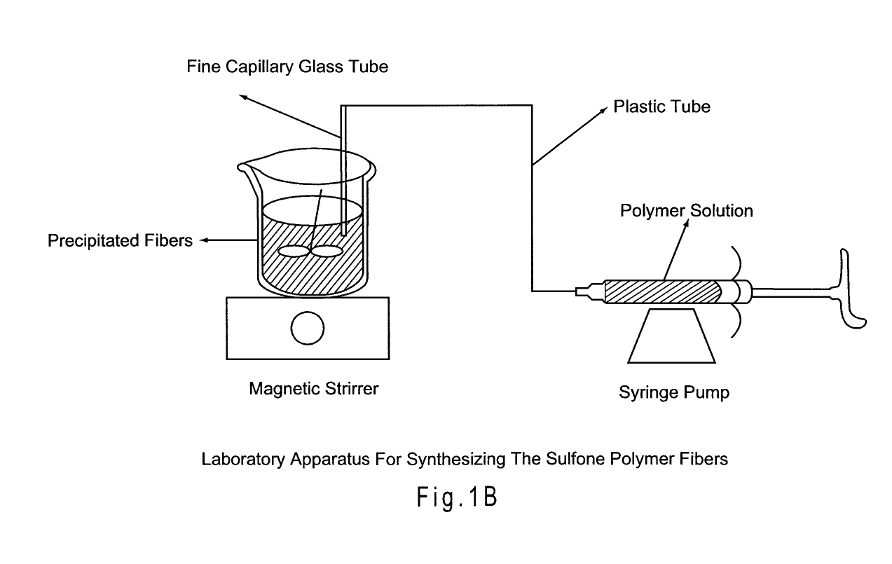

FIG. 1A represents an example of water purification device 100 including colloidal fibers 110. Contaminated water enters the device 100 through inlet 120, passes through a chamber 105, and exits as purified water through outlet 130. Optionally, the device 100 may be equipped with an inlet screen 125 and/or an outlet screen 135. The colloidal fibers 110 adsorb organic matter from the contaminated water passing through the device 100. The screens 125, 135 may provide size exclusion filtration capability to the device 100, in addition to the adsorption provided by the fibers 110. The screens 125, 135 may be formed from perforated plastic disks, sintered glass, sintered plastic, and/or porous cloth, for example. If one or both of the screens 125, 135 are omitted from the device, the fibers 110 may require greater mechanical strength to remain in the device 100 during fluid flow. Thus, when one or both of the screens 125, 135 are omitted, it may be desirable that the fibers 110 have greater lengths and cross-sectional widths, so they are retained in the device 100 as water passes through.

As described in Van Nostrand's Encyclopedia of Chemistry, pp. 272-276 (Douglas M. Considine ed., Van Nostrand Reinhold Co. 1984), colloids are disperse systems with at least one particle dimension averaging in the range of 10⁻⁶ to 10⁻³ mm. Particles may be defined as liquid or solid. Examples include sols (dispersions of solid in liquid), emulsions (dispersions of liquids in liquids), and gels (systems, such as jelly, in which one component provides a sufficient structural framework for rigidity and other components fill the space between the structural units). Preferably, the colloidal particles of the current fibers are sols or sol-gels.

The colloidal particles of the present fibers may be provided by a synthesis that eliminates or substantially reduces the amount of propionic acid (PA) used in relation to conventional methods of producing sulfone polymer colloids. Fritzsche, et al., J. Memb. Sci., 46, pp. 135-55 (1989) describes a conventional polysulfone fiber synthesis where the addition of PA forms a Lewis acid:base pair from the N-methyl-2-pyrrolidine (NMP) and polysulfone components of the reaction mixture. When the resulting polysulfone/NMP/PA acid:base complexes are contacted with water, the NMP dissolves to break the complex and increase the kinetics of the phase separation that forms the colloids. At present, it is believed that a lack of PA significantly slows this phase separation, thus allowing the direct formation of colloidal fibers instead of aggregates.

The colloidal fibers of the present invention may be precipitated when a solution containing a sulfone polymer is added to a liquid in which the polymer has lower solubility than the solvent of the solution. The solution is formed by dissolving the sulfone polymer in a solvent or mixture of solvents that has a higher solubility toward the polymer. Various solvents, solvent mixtures, surfactants, and wetting agents may be used to tailor the morphology of the fibers. While many large-scale production methods may be used, as known to those of ordinary skill in the art, a syringe pump is appropriate on the laboratory scale. A representative laboratory scale synthesis apparatus is shown in FIG. 1B.

Polymers useful in the present invention include, sulfone homopolymers and copolymers such as polymers of polysulfone, polyethersulfone, polyphenylsulfone, and sulfonated polysulfone; homopolymers and copolymers of cellulose acetate, polyacrylonitrile (PAN), polyetherimide, and poly(vinylidene fluoride) (PVDF); and mixtures thereof. Such polymers may be purchased from AMOCO PERFORMANCE PRODUCTS, INC. (Alpharetta, Ga.) under the trade names of UDEL (polysulfone), MINDEL (sulfonated polysulfone), RADEL-A (polyethersulfone), and RADEL-R (polyphenylsulfone). They also are available from ALDRICH, Milwaukee, Wis.

Suitable average molecular weights (AMW) for polysulfone polymers useful in the present invention range preferably from 10,000 to 45,000, more preferably from 17,000 to 35,000, and most preferably from 26,000 to 27,000. Suitable average molecular weights for polyethersulfone useful in the current invention range from 8,000 to 28,000, preferably from 13,000 to 23,000, and most preferably from 16,000 to 20,000. Suitable average molecular weights for poly(vinylidene fluoride) useful in the current invention range preferably from 100,000 to 600,000, more preferably from 180,000 to 534,000, and most preferably from 275,000 to 530,000. Suitable average molecular weights for polyacrylonitrile useful in the current invention range preferably from 30,000 to 150,000, more preferably from 60,000 to 110,000, and most preferably from 80,000 to 90,000. All average molecular weights are weight average molecular weights.

The solution containing the polymer includes the polymer and one or more solvents in which the polymer demonstrates solubility. Any solvent that permits colloid formation when the polymer solution is added to a liquid in which the polymers have lower solubility may be used. Suitable solvents include N-methyl pyrrolidine (NMP), N,N-dimethylformamide (DMF), dimethyl sulfoxide (DMSO), acetone, and dioxane, and are available from ALDRICH, Milwaukee, Wis.

Additionally, surfactants may be added to the solution to stabilize the fibers and otherwise vary their morphology. While any surfactant, including anionic, cationic, or non-ionic, may be used, preferable surfactants include sodium lauryl sulfate, TRITON X-45, and TRITON X-100, or mixtures thereof. Wetting agents, such as alcohols, may also be added.

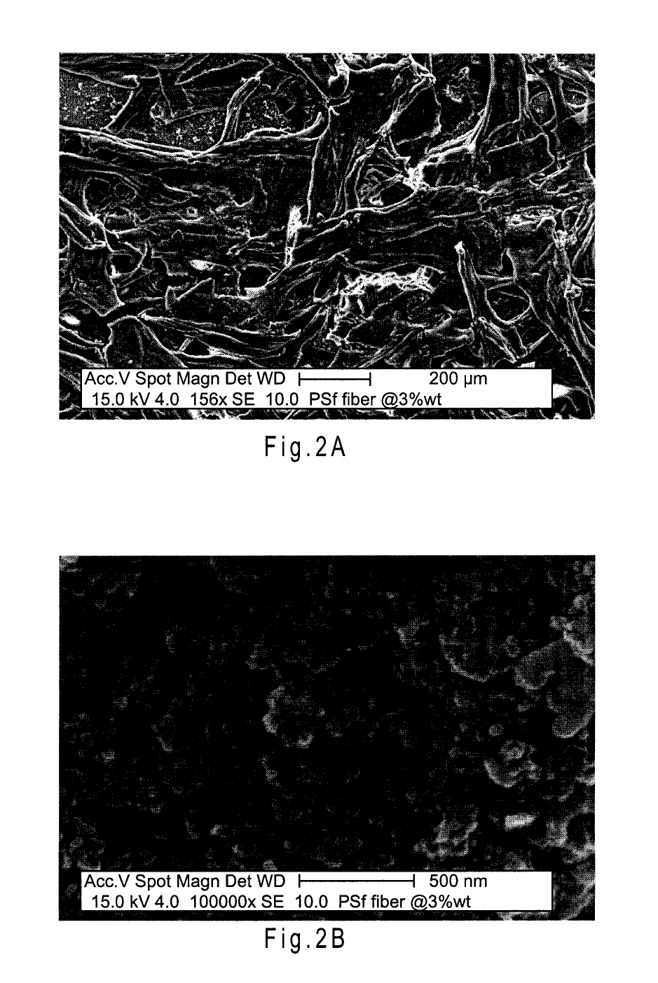

FIG. 2A depicts scanning electron micrograph (SEM) image of white fibers, approximately 2,000 to 3,000 μm in length, resulting from polysulfone having 50 to 80 C₂₇H₂₂SO₄ monomer units per polymer (AMW from 22,000 to 35,000). FIG. 2B depicts a high resolution SEM image of the surface of one of the fibers depicted in FIG. 2A. FIG. 2B establishes that on the nanometer scale, the colloidal particles that form the fibers are similar to those previously observed in the aggregates described in U.S. Pat. No. 6,669,851. Thus, the colloidal particles that form the fibers of the present invention may have individual diameters of preferably from 10 to 1000 nanometers (nm), more preferably from 25 to 500 nm, and most preferably from 50 to 100 nm. Thus, while the microstructure of the fibers is significantly different from that of the prior aggregates, the nanostructure is similar.

When the fibers of the present invention are added to water containing organic matter, the contaminating organic matter may be adsorbed. The addition may be carried out in any appropriate vessel, reactor, column, and the like. Although variables, including temperature, contaminant concentration, and fiber concentration affect the rate of adsorption, the organic matter is typically adsorbed onto the fibers within minutes to hours, preferably within minutes.

Organic matter includes hydrocarbons, hydrophobic pollutants, or pollutants with mixed hydrophobic/hydrophilic properties that pollute water by imparting an undesirable color, taste, odor, or toxicity, as well as any other carbon-containing compound. Preferably, the present invention removes natural organic matter, such as the carbon containing material typically found in drinking water supplies. Although many types of organic matter contaminants may be found in water, humic acid is one of the most common. Other organic matter contaminants include benzene, toluene, proteins, polyscaharides, lipids, geosmin (a natural organic compound leached from soils), 2-methylisoborneol (MIB) (a natural organic compound of aquatic biological origin), membrane foulants, and endocrine disrupters, such as Atrazine, DDT, dioxin, estradiol, estrone, and testosterone. In the case of the hormones, removal may involve absorption rather than adsorption, as these pollutants have a high relative partitioning in polysulfone Purified water is formed by passing the contaminated water over the fibers.

Generally, membranes fouled with organic matter may be cleaned with acids, bases, or surfactants. In one aspect, the present fibers may be regenerated by isolating the fibers from the source of contaminated water and treating them with an alkali solution. Exposing the fibers to the alkali solution desorbs the organic matter from the fibers. Although the alkali solution may be of any concentration, it preferably has a free hydroxide concentration of 1×10⁻⁴ to 10 N, more preferably of 1×10⁻³ to 5 N, and most preferably of 1×10⁻² to 1 N. Any alkali solution may be used, such as a solution of sodium hydroxide, ammonium hydroxide, potassium hydroxide, calcium hydroxide, or mixtures thereof. Sodium hydroxide is presently preferred. Once the contaminants and alkali solution is flushed from the fibers, they may be reintroduced into the source of contaminated water to generate purified water.

The following examples are provided to illustrate one or more preferred embodiments of the invention. Numerous variations can be made to the following examples that lie within the scope of the invention.

### EXAMPLES

### Example 1

### Synthesis of Polysulfone Fibers

A 3% (by weight) solution of polysulfone in NMP was prepared by dissolving 1.65 g of polysulfone powder (Udel P-3500, [C₂₇H₂₂SO₄]_{N-50-80}) in 53.35 g NMP (1-methyl-2-pyrrolidone, Sigma-Aldrich, St. Louis, Mo.). Thus, (1.65 g/(1.65 g+53.53 g)*100=3%. Polysulfone solutions including higher concentrations of polysulfone to NMP, such as 4, 6, or 8%, also were prepared in a similar manner. The polysulfone/NMP solution was pumped into a precipitation bath containing deionized water using a syringe pump at the rate of 1.5 mL/hr. The solvent was removed by dialyzing the fiber solution against deionized water.

### Example 2

### Measuring the Surface Area of the Fibers

The surface area of colloidal fibers prepared in accord with Example 1 was measured using nitrogen adsorption. In Table II, below, the results were compared with those obtained from colloidal aggregates synthesized in accordance with U.S. Pat. No. 6,669,851. The Total Surface Area was determined using the Brunauer, Emmett, and Teller (BET) method of nitrogen adsorption. Adsorption was determined using the Barret, Joyner, and Halenda (BJH) method.

TABLE II

| | Fiber | Colloidal Aggregates |
|---|---|---|
| Total Surface Area | 80.3 m²/g | 104.8 m²/g |
| | (R² = 0.9999) | (R² = 0.9999) |
| Microporous Surface Area | −2.2 m²/g | −0.29 m²/g |
| (t-plot) | (R² = 0.9985) | (R² = 0.9987) |
| Interstitial Surface Area | 79.3 m²/g | 104.2 m²/g |
| Between the Particles Based | | |
| on 1.7 to 300 nm Cylinders | | |
| (BJH adsorption cumulative) | | |
| Average Distance Between | 15.6 mm | 25.2 mm |
| Particles | | |
| (BJH adsorption) | | |

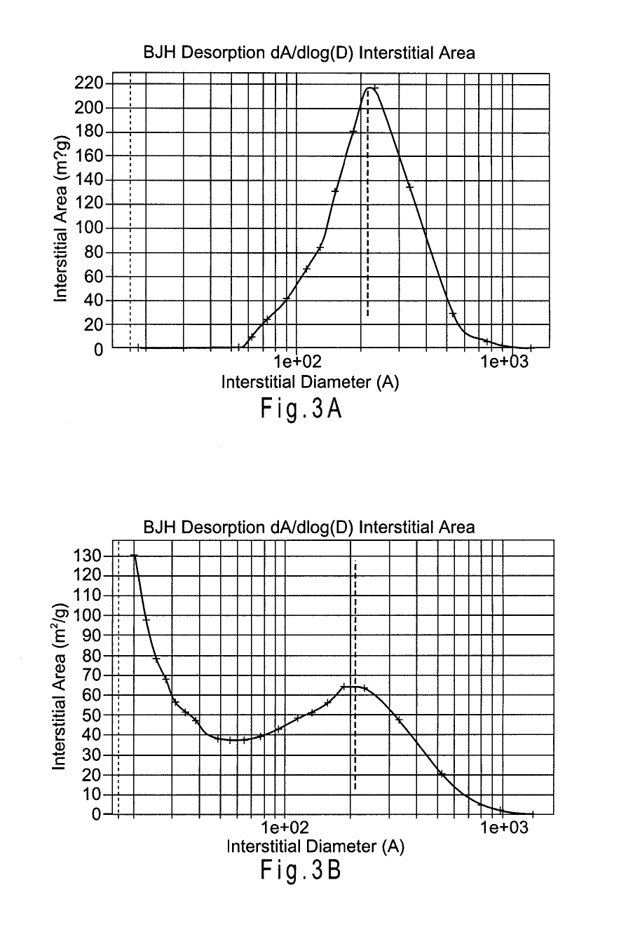

The total surface area of the fibers was determined to be approximately 20% smaller than that of the colloidal aggregates. The fibers also demonstrated a smaller effective interstitial distance between particles in relation to the prior aggregates. Further analysis of the nitrogen desorption data suggest that the new fibrous material (FIG. 3B) contains a bimodal distribution of the interstitial distances between the particles, including a very small interstitial distance not present in the prior colloidal aggregates (FIG. 3A). The presence of the smaller interstitial distances between the particles in the fibers is presently believed to lower the overall mesoporous surface area of the fibers, when compared to the prior colloidal aggregates.

### Example 3

### Fouling Mitigation

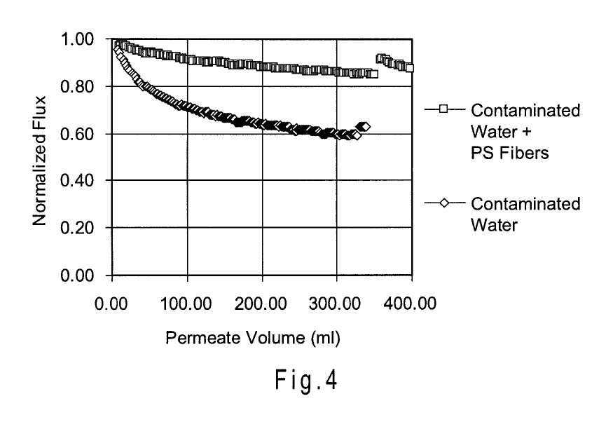

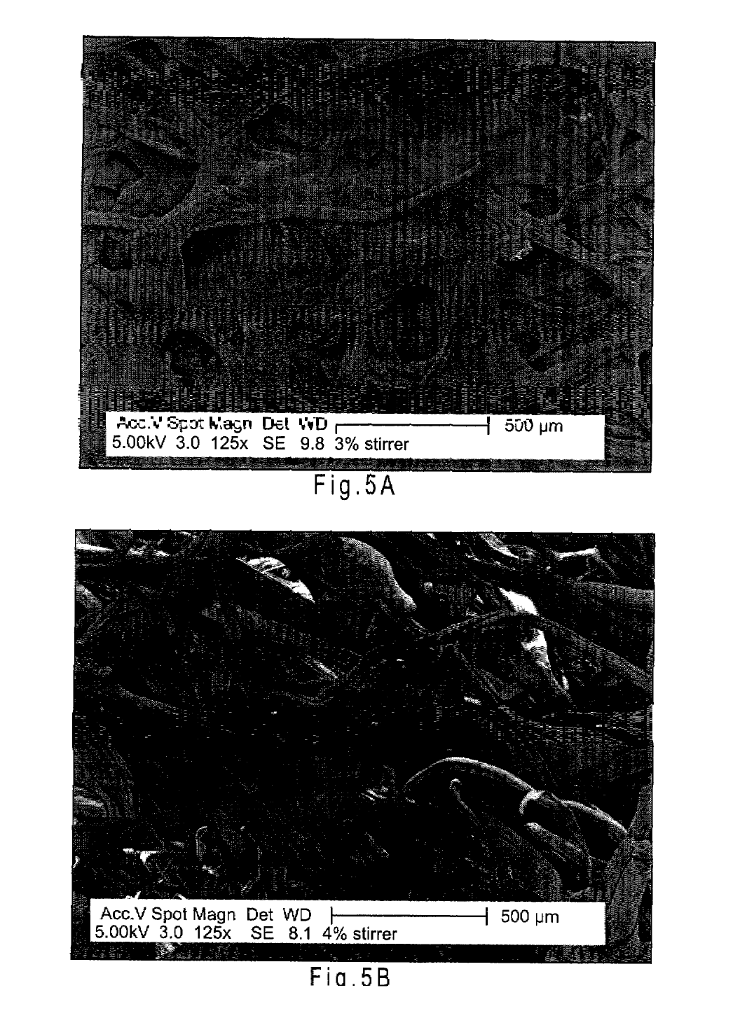

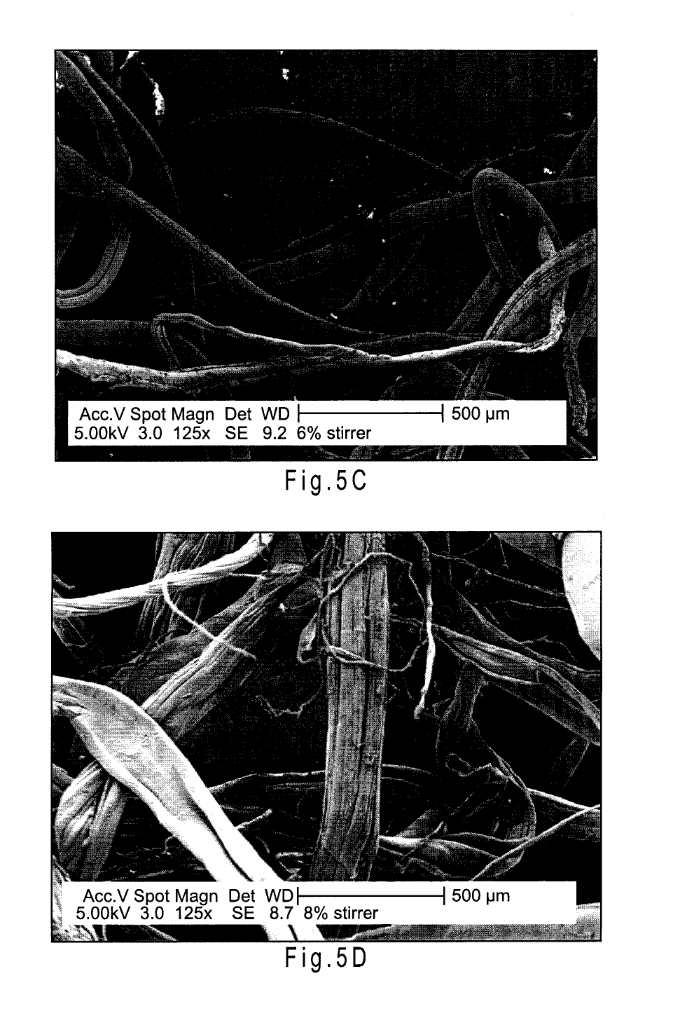

The ability of colloidal fibers prepared in accord with Example 1 to resist fouling was determined using a fouling reduction technique representing the ability of the colloidal fibers to reduce fouling in relation to a conventional water filtration membrane when contacted with a natural water supply. Fifty mg/L of the fibers was mixed with Lake Michigan water for 24 hours and filtered at constant pressure through a 20 kD PES ultra-filtration membrane, as described in Clark et al., “Formation of Polysulfone Colloids for Adsorption of Natural Organic Foulants,” Languir, 21, 7207-13 (2005). FIG. 4 compares flux decline for raw lake water and lake water passed over the fibers. While the untreated lake water resulted in a flux decline of about 40%, the water treated with the fibers resulted in a flux decline of about 15% for the same amount of filtered water. In this respect, the performance of the fibers was similar to that of the prior colloidal aggregates.

Initial experiments have shown that the kinetics of contaminant adsorption by the fibers may be slower than for the prior colloidal aggregates. This slowing is presently attributed to the fibers being thicker, thus having a larger microstructure, than the aggregates. Having a larger average cross-sectional width than the average diameter of the prior colloidal aggregates, slower adsorption kinetics would be expected for the fibers.

### Example 4

### Determining Total Surface Area

To determine the total surface area using the BET method, the surface area and pore size of the colloidal fibers prepared in accord with Example 1 were measured by N2 adsorption, with an ASAP 2010 instrument, available from Micromeritics, Norcross, Ga. Before surface analysis, the colloidal fibers were prefiltered through a 0.22 μm filter (TCMF, Millipore, Billerica, Mass.) and dried at 65° C. overnight. Degassing was conducted at a temperature of 50° C. overnight. The adsorption data were fitted with the Brunauer-Emmett-Teller (BET) model to calculate the surface area. The interstitial distance between the particles was calculated from the adsorption data using the Barret-joyner-Halenda (BJH) model.

While various embodiments of the invention have been described, it will be apparent to those of ordinary skill in the art that other embodiments and implementations are possible within the scope of the invention. Accordingly, the invention is not to be restricted except in light of the attached claims and their equivalents.

1. Fibers comprising colloidal particles comprising a sulfone polymer, the colloidal particles having average diameters from 10 nm to 1000 nm, where
the fibers have an average cross-sectional width from 35 to 400 μm and a length at least three times the average cross-sectional width.

2. The fibers of claim 1, where the sulfone polymer is selected from the group consisting of copolymers and homopolymers of polysulfone, polyphenylsulfone, sulfonated polysulfone, copolymers of polyethersulfone, and mixtures thereof.

3. The fibers of claim 1, where the length is at least 5 times the average cross-sectional width.

4. The fibers of claim 3, where the length is at least 10 times the average cross-sectional width.

5. The fibers of claim 3 having an average cross-sectional width from 40 to 250 μm.

6. The fibers of claim 3 having a BET surface area of 20 to 100 m²/g.

7. The fibers of claim 3, the sulfone polymer having a molecular weight of 13,000 to 23,000.

8. The fibers of claim 3, the sulfone polymer having a molecular weight of 16,000 to 20,000.

9. The fibers of claim 3, where the sulfone polymer is a homopolymer or a copolymer of polysulfone.

10. The fibers of claim 9, the sulfone polymer having a molecular weight of 17,000 to 35,000.

11. The fibers of claim 9, the sulfone polymer having a molecular weight of 26,000 to 27,000.

12. A method of purifying the fibers of claim 3, comprising:
contacting the fibers of claim 3 with organic matter to yield fibers comprising organic matter; and
contacting the fibers comprising organic matter with an alkali solution.

13. The method of claim 12, the organic matter comprising at least one member selected from the group consisting of humic acid, lipids, proteins, polysacharides, geosmin, and 2-methyl isoborneol.

14. The method of claim 12, the alkali selected from the group consisting of sodium hydroxide, potassium hydroxide, ammonium hydroxide, calcium hydroxide, and mixtures thereof.

15. A device for purifying water comprising:
a chamber having an inlet and an outlet; and
colloidal fibers within the chamber, the colloidal fibers comprising colloidal particles comprising a sulfone polymer, the colloidal particles having average diameters from 10 nm to 1000 nm, where
the fibers have an average cross-sectional width from 35 to 400 μm and a length at least three times the average cross-sectional width.

16. The device of claim 15, further comprising activated carbon.

17. (canceled)

18. (canceled)

19. In a device for purification of water, including activated carbon and optional chemical adsorption resins, the improvement comprising substitution of at least a portion of the activated carbon with fibers comprising colloidal particles comprising a sulfone polymer, the colloidal particles having average diameters from 10 nm to 1000 nm, where
the fibers have an average cross-sectional width from 35 to 400 μm and a length at least three times the average cross-sectional width.

20. A method of making fibers comprising:
mixing a solution and water to form the fibers, the solution comprising a sulfone polymer and a solvent, where
the fibers have an average cross-sectional width from 35 to 400 μm and a length at least three times the average cross-sectional width.

21-25. (canceled)

26. In a colloid comprising a sulfone polymer selected from the group consisting of copolymers and homopolymers of polysulfone, polyphenylsulfone, sulfonated polysulfone, copolymers of polyethersulfone, and mixtures thereof; where particles of the colloid have an average cross-sectional width of 10 nm to 1000 nm, the improvement comprising forming the colloids into fibers the fibers having an average cross-sectional width from 35 to 400 μm and a length at least three times the average cross-sectional width.

27. (canceled)

28. A method of removing organic matter from water, comprising:
flowing the water over fibers comprising a sulfone polymer selected from the group consisting of copolymers and homopolymers of polysulfone, polyphenylsulfone, sulfonated polysulfone, copolymers of polyethersulfone, and mixtures thereof, where the fibers have a length at least three times an average cross-sectional width and the average cross-sectional width is from 35 to 400 μm.

29-31. (canceled)
